(19) United States
(12) Patent Application Publication
(10) Pub. No.: US 2010/0228532 A1
(43) Pub. Date: Sep. 9, 2010

(54) METHOD TO CREATE AN INDEX ON MANAGEMENT OF THE TRANSITION PERIOD AND TO PREDICT FIRST LACTATION MILK PRODUCTION

(76) Inventor: Gamal Abdel-Azim, Appleton, WI (US)

Correspondence Address: Intellectual Property Dept.;Dewitt Ross & Stevens SC, 2 East Mifflin Street, Suite 600, Madison, WI, 53703-2865, US

(21) Appl. No.: 12/716,662

(22) Filed: Mar. 3, 2010

Related U.S. Application Data
(60) Provisional application No. 61/156,905, filed on Mar. 3, 2009.

(51) Int. Cl. G06F 17/11

(52) U.S. Cl. 703/2

(57) ABSTRACT

A computer implemented method and system for creating an index on management of the transition period and for calculating predicted milk production for an animal such as a dairy cow during a current lactation period. The calculation is made based on individual characteristics of the animal without relying on factors related to a previous lactation, so an accurate prediction may be obtained for first lactation milk production. In a preferred embodiment, the milk production prediction is based on predicted transmitting ability (PTA) for milk for the individual animal in combination with one or more other factors related to the current state of the animal.

### REFERENCE TO RELATED APPLICATION

The application claims priority to U.S. Provisional Application entitled “METHOD FOR PREDICTING FIRST LACTATION MILK PRODUCTION, Ser. No. 61/156,905, filed Mar. 3, 2009, which is incorporated herein by reference in its entirety.

### FIELD OF THE INVENTION

This invention pertains generally to systems and methods for creating an index of management of the transition period and methods for predicting milk production for individual animals and herds during the transition period into the first lactation.

### BACKGROUND OF THE INVENTION

In herds of milk-producing animals such as dairy cows, the management of individuals during the transition period of the lactation is very important. This is because the transition performance of an individual animal is highly influenced by health and/or disease, both of which can, in turn, be affected by management practices, i.e., the better the transition performance of an individual, the greater her overall health and productivity in the current lactation. Monitoring the transition performance of milk-producing animals is therefore of great importance to informing transition program management practices. A review of these basic concepts can be found in Kenneth V. Nordlund and Nigel B. Cook, Using herd records to monitor transition cow survival, productivity, and health (Vet. Clin. N. Am. Food Anim. Prac. 20: 627-649, November 2004) hereinafter incorporated by reference in its entirety.

Many available methods for evaluating transition performance fail to provide unbiased and objective measures of transition performance for individual animals. The ability to monitor change and to evaluate the success of innovations at a farm level using such methods is relatively crude. Herd managers implement new transition management practices and evaluate the response within their herd using a variety of factors. Many dairies have health records to allow them to track changes in the number of disease events on their own dairy, but inconsistencies in case definition make it difficult to compare disease rates both within and between farms. Milk production monitors in early lactation are often based upon average performance of the animals that calve in a short period of time. These are easily skewed by a small number of either better or poorer animals that freshen a month earlier or later. Herd effects therefore confound the results. Other production monitors based upon First Test Day information are frequently confounded by variations in days in milk at First Test Day.

For the foregoing reasons there was a need for a method which objectively and accurately predicts an individual milk-producing animal's current milk performance based on objective measures of her own past performance and current state, and which monitors the transition programs of individuals and herds so that the health and productivity of both individuals and herds of individuals may be optimized through informed transition programs. Such a method is described in U.S. patent application Ser. No. 11/278,114 by Kenneth V. Nordlund et al., entitled METHOD FOR OPTIMIZING HEALTH AND PRODUCTIVITY OF MILK PRODUCING ANIMALS, the details of which hereby are incorporated herein by reference. This method provides means for accurately predicting, based on objective measures of her own individual previous lactation's performance and current state, an individual milk-producing animal's expected current milk performance, particularly during the early phase of the current lactation, or transition period, which is highly influenced by health and/or disease. This method further provides for utilizing this prediction to calculate a monitor of transition performance of individuals and herds during the early phase of current lactations for use in analyzing transition programs in order to better manage both individuals and herds for optimal health and productivity.

A significant limitation of this method of predicting milk production is that it is based, in part, on objective measures of the animal's past milk production performance, specifically, for cows, the actual previous 305 day yield, or a projection based on the last test day. However, previous milk production data is not available for heifers or other animals entering into their first productive lactation period. Thus, this previous method of predicting milk production is of limited accuracy and value for first lactation animals. This is significant, as, for example, heifers may constitute a significant portion, e.g., typically about one-third, of a typical dairy cattle herd.

What is desired, therefore, is a new and improved method for predicting milk production for first lactation animals that does not rely on factors related to previous lactations.

### SUMMARY OF THE INVENTION

Accordingly, the present invention is directed to a method of using a computer for calculating a prediction of milk production for one or more milk-producing animals without relying on factors related to the milk-producing animals' previous lactations so as to enable its use in evaluating and optimally managing the health and productivity of the one or more milk-producing animals comprising accessibly storing an animal data set comprising, for each of one or more milk-producing animals, a predicted transmitting ability for milk (PTA MILK), and a current number of days in milk at a test day (CURR DIM); accessibly storing a parameters data set comprising a regression coefficient intercept or overall mean (α), a regression coefficient associated with PTA MILK (β), and a regression coefficient associated with CURR DIM (ε); for each of the one or more individual milk-producing animals, calculating an expected or predicted amount of milk produced by the individual milk-producing animal in the current lactation for the given time period (y) by summing α, (β*PTA MILK) and (ε*CURR DIM); for each of the one or more individual milk-producing animals, calculating an index by subtracting the predicted amount of milk produced (y) from an actual amount of milk produced by the individual milk-producing animal in a current lactation for the given time period, which value may be measured and accessibly stored as part of the animal data set; and accessibly storing the predicted milk production (y) and the index for each of the one or more milk-producing animals, and the output as desired for use in evaluating and optimizing health and productivity of the one or more milk-producing animals.

The present invention is further directed to a computer implemented system, comprising a computer usable medium and computer readable code embodied on the computer usable medium for calculating a prediction of milk production of one or more milk-producing animals without relying on factors related to the milk-producing animals' previous lactations so as to enable its use in evaluating and optimally managing the health and productivity of the one or more milk-producing animals, the computer readable code comprising a computer readable code device for accessibly storing an animal input database set comprising for each of one or more milk-producing animals, a predicted transmitting ability for milk (PTA MILK), a current number of days in milk at a test day (CURR DIM); a computer readable code device for accessibly storing a parameter input database set comprising a regression coefficient intercept or overall mean (α), a regression coefficient associated with PTA MILK (β), and a regression coefficient associated with CURR DIM (ε); a computer readable code device configured to cause the computer to effect the, for each of the one or more individual milk-producing animals, calculating of an expected or predicted amount of milk produced by the individual milk-producing animal in the current lactation for the given time period (y) by summing α, (η*PTA MILK) and (ε*CURR DIM); a computer readable code device configured to cause the computer to effect the, for each of the one or more individual milk-producing animals, calculating an index by subtracting the predicted amount of milk produced (y) from an actual amount of milk produced by the individual milk-producing animal in a current lactation for the given time period, which value may be measured and accessibly stored as part of the animal data set; and a computer readable code device configured to cause the computer to accessibly store the predicted milk production (y) and the index for each of the one or more milk-producing animals, and the output as desired for use in evaluating and optimizing health and productivity of the one or more milk-producing animals.

The present invention is also directed to a program storage device readable by a machine, tangibly embodying a program of instructions executable by the machine to perform method steps for calculating a prediction of milk production of one or more milk-producing animals without relying on factors related to the milk-producing animals' previous lactations so as to enable its use in evaluating and optimally managing the health and productivity of the one or more milk-producing animals, the method steps comprising accessibly storing an animal data set comprising, for each of one or more milk-producing animals, a predicted transmitting ability for milk (PTA MILK), a current number of days in milk at a test day (CURR DIM); accessibly storing a parameters data set comprising a regression coefficient intercept or overall mean (α), a regression coefficient associated with PTA MILK (β), and a regression coefficient associated with CURR DIM (ε); for each of the one or more individual milk-producing animals, calculating an expected or predicted amount of milk produced by the individual milk-producing animal in the current lactation for the given time period (y) by summing α, (β*PTA MILK) and (ε*CURR DIM); for each of the one or more individual milk-producing animals, calculating an index by subtracting the predicted amount of milk produced (y) from an actual amount of milk produced by the individual milk-producing animal in a current lactation for the given time period, which value may be measured and accessibly stored as part of the animal data set; and accessibly storing the predicted milk production (y) and the index for each of the one or more milk-producing animals, and the output as desired for use in evaluating and optimizing health and productivity of the one or more milk-producing animals.

The present invention is also directed to an apparatus for calculating a prediction of milk production of one or more milk-producing animals without relying on factors related to the milk-producing animals' previous lactations so as to enable its use in evaluating and optimally managing the health and productivity of the one or more milk-producing animals, the apparatus comprising means for accessibly storing an animal data set comprising, for each of one or more milk-producing animals, a predicted transmitting ability for milk (PTA MILK), a current number of days in milk at a test day (CURR DIM); means for accessibly storing a parameters data set comprising a regression coefficient intercept or overall mean (α), a regression coefficient associated with PTA MILK (β), and a regression coefficient associated with CURR DIM (ε); means for each of the one or more individual milk-producing animals, calculating an expected or predicted amount of milk produced by the individual milk-producing animal in the current lactation for the given time period (y) by summing α, (β*PTA MILK) and (ε*CURR DIM); means, for each of the one or more individual milk-producing animals, for calculating an index by subtracting the predicted amount of milk produced (y) from an actual amount of milk produced by the individual milk-producing animal in a current lactation for the given time period, which value may be measured and accessibly stored as part of the animal data set; and means for accessibly storing the predicted milk production (y) and the index for each of the one or more milk-producing animals, and the output as desired for use in evaluating and optimizing health and productivity of the one or more milk-producing animals.

The present invention provides a method and system for objectively and accurately predicting an individual milk-producing animal's milk production without relying on factors related to previous lactations. Thus, the present invention is well suited to milk production prediction for first lactation animals. Milk production predictions calculated in accordance with the present invention may be compared to actual measured current milk production in order to monitor the production programs of individual animals and herds so that the health and productivity of both individuals and herds of individuals may be optimized.

A system and method in accordance with the present invention provides for the prediction of, based on objective measures of her current state, but not using her own individual previous lactation's performance, an individual milk-producing animal's expected milk production, particularly during the early phase of the current lactation, or transition period, which is influenced by health and/or disease. The present invention further provides for utilizing this prediction to calculate an index of individuals and herds during the early phase of current lactations for use in analyzing production programs in order better to manage both individuals and herds for optimal health and productivity. In particular, the milk production predictions provided in accordance with the present invention will be useful in identifying heifers and other first lactation animals that are experiencing transition problems.

In one embodiment, the present invention provides a method of using a computer for calculating a prediction of current milk production for one or more milk-producing animals at a given time period in a current lactation so as to enable its use in evaluating and optimally managing the health and productivity of the one or more milk-producing animals. The method in accordance with the present invention generally consists of accessibly storing an animal data set comprising, for each of one or more milk-producing animals, a predicted transmitting ability for milk (PTA MILK), and various other factors, such as a current number of days in milk at a test day (CURR DIM). A parameters data set comprising α, a regression coefficient intercept or overall mean, and regression coefficients β, associated with PTA MILK, and ε, associated with CURR DIM is also accessibly stored. For each of said one or more individual milk-producing animals, an expected or predicted amount of milk produced (y) by the individual in the current lactation for the given time period is calculated by summing α, (β*PTA MILK) and (ε*CURR DIM). For each of said one or more individual milk-producing animals, an index may be calculated by subtracting the predicted amount of milk produced (y) from an actual amount of milk produced by the individual in a current lactation for the given time period, which value may be measured and accessibly stored as part of the animal data set. The predicted milk production (y) and the index may be accessibly stored for each of said one or more milk-producing animals, and output as desired for use in evaluating and optimizing health and productivity of the one or more milk-producing animals.

Thus, the present invention provides a method for calculating the expected amount of milk produced by an individual milk-producing animal in its current lactation based on the individual's characteristics and other parameters related to its current state, but that are not related to the individual's actual performance in its previous lactation, in order to monitor the individual's transition performance. It is usable for evaluating and optimizing the individual's health and productivity.

In another embodiment of the present invention, a herd-level milk production or index value may be calculated as an average over all individual animals in a herd.

In still another embodiment of the present invention, sire-specific production and index values may be calculated by averaging individual values calculated in accordance with the present invention for all daughters of a sire.

In other embodiments of the present invention, various other factors unrelated to previous lactation may be used, in addition to those described above, to calculate a current milk production prediction for first lactation animals.

In other embodiments of the present invention an apparatus, computer program product, and program storage device for performing the method of the present invention are provided.

The method of the present invention is a method of using a computer for calculating predicted current milk production for one or more milk-producing animals so as to enable its use in evaluating and optimally managing the health and productivity (e.g., the transition performance) of those individual animals and of their herds. It should be noted that, though the equations and tables of parameter values that follow are specifically directed to dairy cows, the basic methodology of calculating expected amounts of milk that an individual will produce in a current lactation based on the individual's current state, but without using any previous lactation information, calculating index values based on the same, and using the results of these calculations for those same individuals to evaluate and to optimize individual and herd health and productivity, can be applied across species or breeds of milk producing mammals, provided sufficient and appropriate data are available for accessible storage as part of the animal and parameters data sets (to be described in more detail below).

Calculating an index value for each individual animal and given time period based on projected milk production calculated in accordance with the present invention, using that individual's own data, effectively makes the animal her own control, yielding a quantifiable measure of the individual's transition performance unbiased by herd effects and thereby greatly improved over traditional methods of monitoring fresh cow performance. Thus, the present invention may be used for evaluating an individual animal's transition performance and in making better informed transition program management decisions for optimizing the individual's health and productivity. Additionally, successive testing on different test days within an animal's current lactation may also be used as an on-going monitor of the cow and to enable early detection of health problems.

Likewise, when production prediction and/or index values are compiled for whole herds, herd-level management decisions and resulting health and productivity of the herd may be optimized. By averaging predicted production and/or index for all animals within a herd, herd managers may objectively compare the effectiveness of their transition management programs to industry benchmarks. Both within and between herds comparisons may be made. Furthermore, predicted production calculated in accordance with the present invention and/or values derived therefrom for a herd may be monitored over time in order to track ongoing fresh cow performance and evaluate the effectiveness of management changes that may be implemented with transition animals.

Further features, aspects, and advantages of the present invention will be better understood with reference to the following description, accompanying drawings, and any appended claims of this application.

### BRIEF DESCRIPTION OF THE DRAWINGS

FIG. 1 is a flow chart diagram depicting basic steps in one exemplary embodiment of a method in accordance with the present invention.

FIG. 2 is a schematic block diagram of an exemplary system in accordance with the present invention.

### DETAILED DESCRIPTION OF THE INVENTION

Referring now specifically to the figures, in which identical or similar steps or parts are designated by the same reference numerals throughout, a detailed description of the present invention is given. It should be understood that the following detailed description relates to the best presently known embodiment of the invention. However, the present invention can assume numerous other embodiments, as will become apparent to those skilled in the art, without departing from the appended claims.

It should also be understood that, while the methods disclosed herein may be described and shown with reference to particular steps taken in a particular order, these steps may be combined, sub-divided, or re-ordered to form an equivalent method without departing from the teachings of the present invention. Accordingly, unless specifically indicated herein, the order and grouping of the steps is not a limitation of the present invention.

It should also be understood that, though the following description discloses the invention as adapted for use with dairy cows, particularly with first lactation dairy cows, the system and method of the present invention may be applied to animals in the second or subsequent lactation and to females of other types of milk-producing animals as well, with values for the various individual-specific factors and their respective coefficients being calculated based on data for the particular species or breed.

### Abbreviations and Definitions:

AGE CURR CALV: Age in months at current calving.

AIPL: Animal Improvement Programs Laboratory

CURR DIM: Current number of days in milk at a test day.

CURR LACT CODE: Current lactation starting code, a code indicating whether or not lactation began following an abortion or following a normal calving.

CURR MILKING FREQ: Current lactation's milking frequency as of the test day.

Dairy Management Software: Dairy herd management software that may use milk yield data retrieved from DRPC records centers or from parlor software systems.

DRPC: Dairy Records Processing Center are organizations that measure milk yield of cows, determine percent fat, percent protein, and other milk tests, and provide dairy herd and cow information management tools to participating dairy herds.

First Test Day: The First Test Day is the day an animal's milk production is first tested in her current lactation. Dairy cows average about 19 days in milk at First Test Day, but range from about 5 to 40 days in most cases.

K: MP_expected,time (see below).

Lactation: the period of time during which an animal lactates. A lactation begins after calving and ends when an animal is not milked any longer in preparation for calving again. A lactation for a dairy cow is generally about 300 to 360 days, or 10-12 months long.

LAN: Local Area Network

MO CURR CALV: Month in which the current lactation calving occurred.

MP: Milk production is the amount of milk an animal produces during a certain period of time (”time;” e.g., on her First Test Day, over 305 days of lactation, or the like) and is generally expressed in units of pounds, though equivalent weight units such as kilograms may be used.

MP _actual,time: the amount of milk an animal actually produces or is projected to produce in a certain period of time (“time”). The period of time may be the First Test Day, the first 305-days of a lactation period (“305”) either in her current or previous lactation, or other periods of time (e.g., daily amount, weekly average or the like). The term “actual” is applied, because (a) if the time period is the First Test Day, the amount of milk produced by the animal is weighed and so reflects the actual amount of milk the animal produced; or, (b) if the time period is the first 305 days of the current time period (or another time period), the amount of milk the animal will produce during the first 305 days (or other time period) of the current lactation is projected based on the actual First Test Day amount from (a). For example, MP _actual,first-test is the amount of milk an animal actually produced on her First Test Day of the current lactation provided in units of lbs./day, kilograms/day or similar weight/time equivalents (e.g., a typical dairy cow value might be 80 lbs/day (36 kilograms/day)). MP_actual,305 is the amount of milk an animal is projected to produce in a 305-day period of her current lactation based on the amount of milk she actually produced on her First Test Day (MP_actual,first-test), and other data, and is provided in units of lbs. in 305 days, kilograms in 305 days, or similar weight/time equivalents (e.g., a typical dairy cow value might be 20,000 lbs. in 305 days (9,090 kilograms in 305 days)). Values for the various MP_actual, time amounts are typically provided by a DRPC or other source. Ideally MP_actual, 305 calculations use only individual-specific factors which do not confound the results by introducing herd-level effects, though this may vary by provider. For example, the herd production level adjustment that is sometimes applied to 305-day projections for an animal through the first 155 days of each lactation may be removed from the projection to eliminate a herd-level effect from the calculation.

MP_actual,first-test: amount of milk actually produced on the first test day of the current lactation.

MP_actual,305: amount of milk projected to be produced in 305 days of current lactation based on the MP_actual,first-test value.

MP_expected,time (also referred to herein by the variable “k”): the amount of milk an animal is expected to produce during a period of time (“time”) in her current lactation based on her current state and other factors unrelated to any previous lactation. For example, MP_expected,first-test is the amount of milk an animal is expected to produce on her First Test Day based on her current state and other factors unrelated to any previous lactation. Likewise, MP_expected,305 is the amount of milk an animal is expected to produce over the first 305-day period of her current lactation based on her current state and other factors unrelated to any previous lactation. MP_expected,time (k) values are calculated in accordance with the present invention as disclosed herein. Units are similar to those described above for MP_actual,time.

Parlor Software: Parlor Software refers to milking parlors with meters to measure milk yield of individual cows. Parlor software is non-DRPC milk recording software used by some herd managers to collect and manage their own herd data. Parlor software is generally provided by milking equipment manufacturers.

PTA: Predicted Transmitting Ability is the part of an animal's genetic makeup that is transmitted to offspring. PTAs express the level of genetic superiority or inferiority an animal is expected to transmit to its offspring for a given production or type trait. PTAs for milk producing animals are published for a variety of traits, e.g., milk, fat, protein, etc. (For purposes of the present invention the PTA for milk (PTA MILK) is of interest.) PTA values are used to rank animals based on their genetic merit for the various traits. For young animals, the PTA values are estimated by averaging the parents' PTAs. PTAs are generally provided by the Animal Improvement Programs Laboratory (AIPL) of the USDA. AIPL officially publishes new PTAs for new animals and updates previously published PTAs several times a year as more records become available to AIPL from DRPCs.

PTA MILK: Predicted Transmitting Ability for milk.

Transition programs: management programs designed to improve overall well-being of cows, to increase milk production, and to reduce the risk of disease (both metabolic and infectious in nature) in the period before and after calving. Both the genetic value and the animals' environment come into consideration in this period. Components of transition programs include specific diets to prepare cows for high production, special nutritional additives to prevent metabolic disease, vaccinations to prevent infectious disease, and a multitude of management strategies to minimize social stresses on the cow as she completes her pregnancy and begins her lactation. Transition programs can have a substantial impact on whether or not, or to what extent, newly freshened cows (i.e., cows that have just calved) have disease problems. Good transition programs result in cows that freshen with few disease problems, whose milk production increases rapidly after calving and remains higher throughout lactation. Deficiencies in transition programs can cause such problems as milk fever, retained placenta, ketosis and displaced abomasums, mastitis, and result in reduced milk yield, altered milk components, and premature replacement or death. Accurate monitoring of the transition programs is therefore of great importance.

USDA: United States Department of Agriculture.

WAN: Wide Area Network.

α: a regression coefficient intercept or overall mean.

β: regression coefficient associated with PTA MILK.

ε: regression coefficient associated with CURR DIM.

γ: regression coefficient associated with AGE CURR CALV.

λ: regression coefficient associated with (AGE CURR CALV)².

ζ: regression coefficient associated with CURR MILKING FREQ.

y: the predicted amount of milk produced.

### Detailed Description—Method

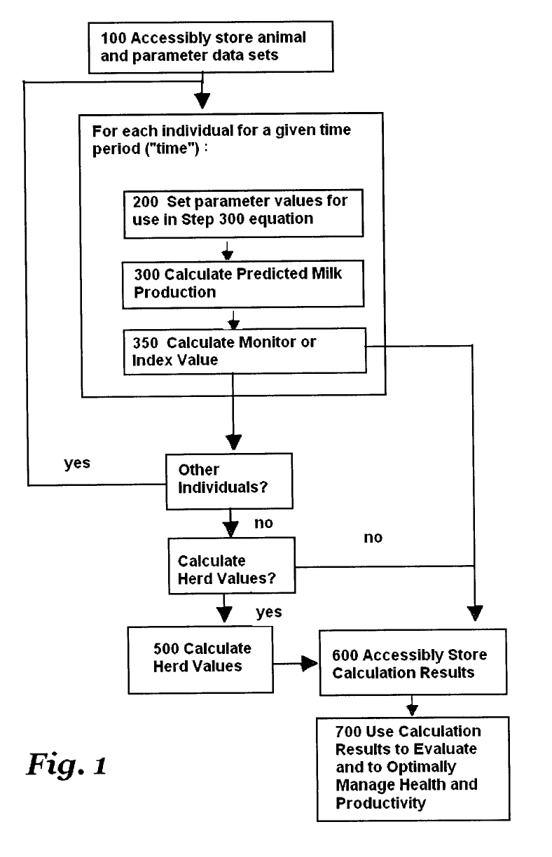

Referring to FIG. 1, the basic steps of a method in accordance with the present invention are depicted. Though the method may be applied to single individual animals, it may generally also be used to evaluate the transition performance of a herd of animals, as will be described in more detail below.

### 100—Accessibly Store Animal and Parameter Data Sets

In accordance with the present invention, animal and parameter data sets are stored 100 in an accessible manner. The steps that follow require that data be provided regarding each animal's current state, but not including any information related to previous lactation, i.e., an animal data set, and also that data be provided regarding the values for the intercept, coefficients and factors used in the milk production prediction calculations to be described in detail below.

The animal data set consists of a variety of individual-specific data such as may be provided by a DRPC or other source with access to that information. The data may typically include:
PTA MILK
MP_actual,first-test
MP_actual,305 without herd production level adjustments
CURR DIM or CURR DIM at the First Test Day
CURR LACT CODE
MO CURR CALV
BREED
CURR MILKING FREQ
AGE CURR CALV
   In addition, the data set may include identification of sire and other relevant data. The variable designations, e.g., PTA MILK, CURR DIM, etc., as used above are arbitrary. They are simply used here as a means to more easily signify the particular type of animal data when referenced in the remainder of this description. Please also note that none of the animal data described is related to previous lactations.

The parameters for the data set include values for the intercept, coefficients and factors used in calculating projected milk production in accordance with the present invention, as described below. These data are based on statistical analyses of data for animals preferably in the relevant region of the country or world and on the time period for which the predicted production values are calculated (e.g., whether for a First Test Day, for a 305-day period, etc.). A model, for example, that was developed from Midwestern United States regional factors would likely be different in the Southeastern or Southwestern regions of the United States, as well as in other regions of the world. A sample of a parameters data set is presented below with values based on the first 305-day time period and Midwestern United States dairy cow data.

Parameter values are generally obtained by fitting a mixed effects model to dairy cow or other animal data, e.g., from the Midwestern United States in the present example. A random effect is fitted (using restricted maximum likelihood) corresponding to the categorical identifier for herd, and otherwise all effects are fitted as fixed effects (using generalized least squares based on the empirical covariance matrix including random effects). The fixed effects terms BREED, CURR LACT CODE, and MO CURR CALV are fitted as categorical (classification) effects (and thus appropriately coded as indicator variables). All other fixed effects are fitted as continuous effects.

Two continuous fixed effects variables were fitted for AGE CURR CALV. First, a linear effect for age was fitted by using age in months at current calving as a fixed variable in the model. Second, a quadratic effect for age was fitted by using the square of age in months at current calving ((AGE CURR CALV)²) as a fixed variable in the model. The linear effect of age accounted for the increased milk production as young animals grew older, and the quadratic effect of age accounted for the disadvantage of extreme age values, i.e., very young and very old animals relative to the current parity. Note that AGE CURR CALV and (AGE CURR CALV)² may be fitted in the model by expressing age in different time units, e.g., years, weeks, days, etc.

The particular values contained in the parameters data set will also depend on whether the expected current milk production prediction amounts are being calculated based on First Test Day milk production values or for 305-day milk production values. The parameters data set will therefore vary depending on type of calculation, i.e., first-day or 305 day expected values, and on source of the animal data used for the statistical analyses, e.g., by region of world or other factors.

As will be evident to the reader, the regression equations for the milk production prediction calculations described herein may also require periodic re-computation with the arrival of new data and new developments in the dairy industry, and whenever milk production or other factors might be modified, in order to provide appropriate values for the intercept, coefficients and factors used to calculate, e.g., expected First Test Day and 305-day expected milk production values. For example, such re-computation may be required due to updates and modifications of the factors used by DRPC centers, or other data sources, to calculate values such as actual milk production projections.

The parameters for data set may include values for the following intercept and coefficients used in the current milk production prediction calculations described below. α is a regression coefficient intercept or overall mean. β is a regression coefficient associated with PTA MILK. ε is a regression coefficient associated with CURR DIM. γ is a regression coefficient associated with AGE CURR CALV. λ is a regression coefficient associated with (AGE CURR CALV)². ζ is a regression coefficient associated with CURR MILKING FREQ.

Further, the parameters for data set include sets of values for each factor. Each factor's actual value applied in the calculation of predicted milk production for an individual animal is set according to the related animal data for the individual. Factors may include:
CURR LACT CODE
MO CURR CALV
AGE CURR CALV
BREED
CURR MILKING FREQ

### 200—Set Parameter Values

Returning to FIG. 1, for each individual animal for a given time period, parameter values are set for use in the milk production prediction at 200. As discussed above, the parameters data set includes sets of values for each factor. The particular factor values used in solving the milk production prediction equations are assigned based on various individual-specific conditions (i.e., conditions specified in the animal data set). In the present step, each factor's actual value applied in the calculation of predicted milk production for an individual animal is set according to the related animal data for the individual. For an example of values for various of the parameters and the conditions under which they are set, see Table 1 below. Values for the intercept and coefficients depend on the animal data used for the statistical analyses and on the type of milk production prediction calculations being performed (e.g., time period is first-test, 305-day, or some other time period).

TABLE 1
Sample values for the intercept and regression coefficients
of variables used in the milk production prediction.

| | | | Regression |
|---|---|---|---|
| Variables | Levels | Type | Coefficient |
| | Intercept | Factor | 4059.727 |
| | PTA MILK | Covariate | 0.803 |
| | AGE CURR CALV | Covariate | 490.594 |
| | (AGE CURR CALV)² | Covariate | −7.445 |
| CURR LACT | Abort | Factor | 0 |
| CODE | Normal | | 2474.319 |
| | CURR DIM | Covariate | 69.992 |
| | CURR MILKING FREQ | Covariate | 482.190 |
| MO CURR | January | Factor | 0 |
| CALV | February | | −5.925 |
| | March | | −291.418 |
| | April | | −220.351 |
| | May | | −241.802 |
| | June | | −256.460 |
| | July | | −482.379 |
| | August | | −568.996 |
| | September | | 63.403 |
| | October | | 247.397 |
| | November | | 346.738 |
| | December | | 87.578 |

Type ‘Factor’ indicates a categorical variable and ‘Covariate’ indicates a continuous variable in the model.

### 300 —Calculate Predicted Milk Production

For each individual animal for a given time period, a predicted value for the animal's milk production in the current lactation is calculated at 300 based on current state and without the use of any factors related to previous lactation.

The milk production prediction calculated is the amount of milk an animal is predicted to produce during a period of time in her current lactation. For example, this value may be calculated as the amount of milk the animal is expected to produce on her First Test Day of the current lactation (lbs. milk/day; kilograms of milk/day) or the amount of milk the animal is expected to produce over the first 305-day period in her current lactation (lbs. milk in 305 days; kilograms of milk in 305 days).

In accordance with the present invention, the milk production prediction values calculated predict the animal's performance in the current lactation based upon the animal's current state as indicated by one or more of the individual's current lactation factor(s) without relying on any factors related to previous lactation. Thus, the calculation may be used for predicting milk production for first lactation animals. Since the calculation uses individual-specific factors it is therefore free from confounding herd effects.

Although the following exemplary equations are specifically for dairy cows, a similar approach may be applied to other types of milk producing animals such as other bovines or sheep and goats, provided sufficient data exist to develop the appropriate regression equations and solve for the various parameter values.

The equation to solve for predicted milk production is the same whether it is employed to calculate First Test Day or 305-day milk production prediction. However, the values assigned to the various parameters (i.e., the intercept, coefficients and factors) will vary.

In its most basic form, predicted milk production y is calculated according to the following algorithm:

y=α+(β*PTA MILK)+(ε*CURR DIM) (Eq. 1a.)

Although Equation 1a contains only two variables, i.e., PTA MILK and CURR DIM, these two variables provide a substantially accurate model for calculating the value for y. Additionally, Equation 1a illustrates a basic innovation of the present invention, i.e., predicting an individual animal's expected milk production (y) based on PTA MILK and current state variables (as represented by CURR DIM) and without the use of any variables related to previous lactation.

The addition of other variables may further refine the model. For example, the following equation (Equation 1b) adds more values to further improve the model's accuracy (CURR LACT CODE and MO CURR CALV factors and AGE CURR CALV):

y=α+(β*PTA MILK)+(ε*CURR DIM)+CURR LACT CODE factor+MO CURR CALV factor+(γ*AGE CURR CALV)+(λ*AGE CURR CALV)²) (Eq. 1b)

Still further refinement of the model may be obtained by the addition of more variables as desired and appropriate. Such as the following:

y=α+(β*PTA MILK)+(ε*CURR DIM)+CURR LACT CODE factor+MO CURR CALV factor+(γ*AGE CURR CALV)+(λ*(AGE CURR CALV)²)+BREED factor+(ζCURR MILKING FREQUENCY) (Eq. 1c)

Although the above-referenced equations are specifically for a single breed of dairy cows, Holstein, the same equation to solve for predicted milk production may be applied to other breeds of dairy cows, e.g., Ayrshire, Lineback, Normandy, Simmental, Brown Swiss, Guernsey, Jersey, among others. However, the values assigned to the various parameters (i.e., the intercept, coefficients and factors) will vary. Because the exemplary equations are for one breed, only one estimate of either the breed factor or the intercept is possible to obtain. If several breeds are to be included then estimates of the breed factor in addition to the intercept are possible to obtain.

### 350—Calculate Monitor or Index Value

Returning once again to FIG. 1, for each individual animal for a given time period, a monitor or index value may be calculated at 350 as the difference between the expected and actual values for her milk production. This value may be calculated as the difference between the expected and actual values for milk production in the animal's current lactation for a given time period (“time”). Values for expected or predicted amounts of milk production for different time periods (i.e., first-test, or 305-day) are calculated according to the equations disclosed above. Values for actual amounts of milk produced by an individual animal are provided by DRPC or other sources, whether for the First Test Day or for the projected 305-day milk production, without the standard herd production level adjustment if less than 155 days in milk, in the current lactation.

The basic equation for the calculation of an individual's monitor or index value is thus:

Index=Actual Milk Production−y (Eq. 2)

Where:
Actual Milk Production is the actual milk production by the individual animal for a particular time period. For example, when the time period is the first-test day, this value is the actual amount of milk the individual produced on that day. However, when the time period is 305 days, “actual” milk production refers to the fact that although the value is a projected value for milk production during the first 305 days of the individual's current lactation, it is based on actual milk production at First Test Day. This value is generally provided by DRPC or other sources.
y is the expected or predicted milk production by the individual for a particular time period and is calculated in accordance with the present invention as described above.

Since actual and expected values may relate to either the individual's milk production on her First Test Day or to her milk production over 305 days of current lactation, the index value may likewise vary accordingly. In other words, this value may be calculated based on First Test Day values or based on 305-day milk production values. Though the order of magnitude of the transition monitor value will vary depending on which types of MP values are used in its calculation (e.g., a first-test value may be on the order of 20 lbs/day (9.1 kilograms/day) versus a 305-day value which may be on the order of 3,000 lbs. in 305 days (1,363 kilograms in 305 days), the relative results will nevertheless similarly indicate transition performance of the animal. Positive values will indicate better transition performance, negative values poorer transition performance.

A positive index indicates that an individual animal exceeded expectations and has experienced a positive transition period. A negative value or index indicates that the animal did not meet expected performance and has experienced a negative transition period. For example, if an animal's 305-day milk production is predicted to be 20,000 pounds (9,090 kilograms) in the current lactation, but actual 305-day production is 22,000 pounds (10,000 kilograms), the value or index is 22,000-20,000=+2,000 lbs. (+909 kilograms). A positive value means the transition program is working well for this particular animal since she is actually producing better than predicted. By contrast, if the index is negative, this indicates some problem with the transition program relating to this animal because she did poorer than predicted.

### 500—Calculate Herd Values

A herd-level value or index may be calculated at 500. Such a value may be calculated by summing individual values over all individuals in the herd and dividing by the number of individuals. As with the individual values, the herd values are based on data for a particular time period, e.g., First Test Day or 305-day period in current lactation. For this reason, herd values will vary relative to the time period. So long as comparisons of herd values within and between herds are made for similar time periods, they will be comparable.

### 600—Accessibly Store Calculation Results

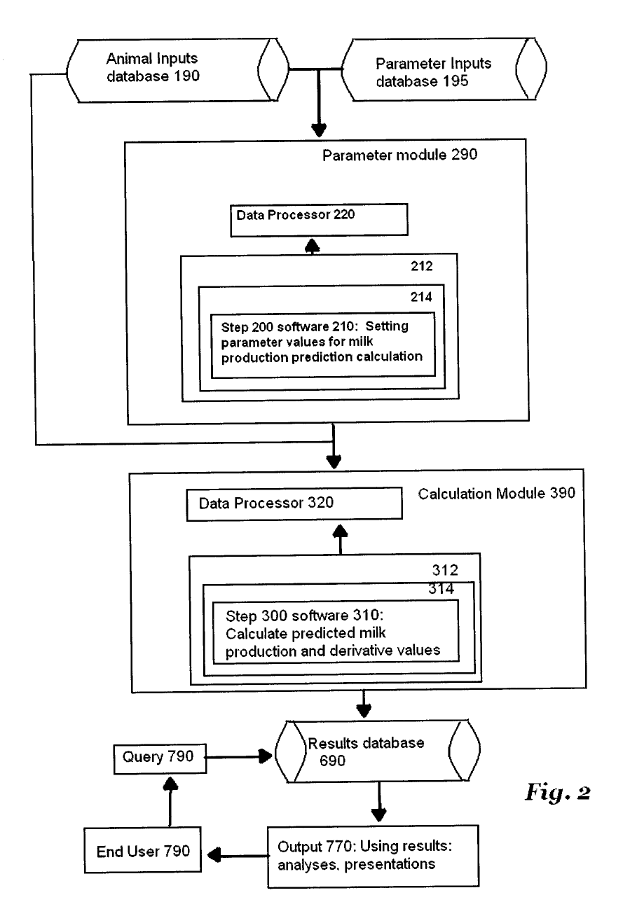

Results from any of the calculations described above may be accessibly stored at 600 in a results database for retrieval and use in subsequent analyses and presentations, etc. These results are then available for use by herd managers and the like to evaluate and optimally manage the health and productivity of individual animals and of herds of animals. The results are accessible to end users 780, as illustrated in FIG. 2, for use in various types of analyses, presentations and the like.

### 700—Use Calculation Results to Evaluate and to Optimally Manage Health and Productivity

The production prediction values as calculated, and other values derived therefrom, may be used at 700 as desired to evaluate and to optimally manage health and productivity of individuals and/or herds.

The calculated values for individual animals and for herds of animals may be used by dairy herd managers to evaluate and manage the health and productivity of those individuals and herds. By evaluating the results to determine if the productivity of individual animals and/or a herd is improving or not, managers can objectively evaluate whether or not their transition program practices are optimizing their health and productivity. If not, changes can be made to those management practices, and the present invention's methodology re-employed to evaluate whether those changes are improving health and productivity or not.

Within and between herd comparisons. Because the calculated values are objective measures, they may be used to compare within herd management practices such as differences between the transition programs applied to different individuals within the herd, differences in practices employed during different periods of time, and so on. Likewise, the calculated values may be compared between herds to determine if management practices applied to one herd are more or less optimal than those applied to another.

Informing breeding programs to improve herd genetics. In addition to within or between herd evaluations, other uses may also be made of the calculated values. For example, the individual calculated values may be used to identify sires with the genetic tendency to father offspring with good health and productivity during transition periods which, together with the transition monitor values for individual animals, may be used to inform breeding programs in order to further improve the genetic health and productivity of herds.

To accomplish this, the animal data set may further include an identity of each animal's sire. The calculated values for individual animals may then also be associated with the animal's sire. An average value for each sire may then be calculated as an average of transition monitor values over all the sire's daughters. As will be evident to the reader, such sire values may be tracked to evaluate the genetic tendency of a sire to produce offspring of greater or lesser levels of health and productivity, particularly during the early phase of current lactations. Knowing the genetic tendencies of various sires may better inform herd breeding programs. Herd managers may, for example, select sires with higher positive index values to improve progeny of an animal whose monitor or index values are low.

Early identification of sick animals. Another use of the above transition calculated values may be to calculate them on a daily basis in parlor software linked to milking parlors with daily milk weights. If done on a daily basis in the first weeks after calving, such values could assist herdsmen to identify sick animals at earlier stages of illness and improve response to treatment.

### Detailed Description—System

An exemplary computer-implemented system in accordance with the present invention is illustrated in FIG. 2. A general-purpose computer, its component devices, and general-purpose along with specialized software, provide the physical structure for implementing the method steps described above.

Animal inputs database 190 and parameters inputs database 195 are provided respectively. Accessibly stored in the databases 190 and 195 are the animal data set in database 190, the parameters data set in database 195 and any other data relevant to the calculations.

In a parameter module 290, individual-specific parameter values are set for use in calculating predicted milk production in accordance with the present invention in conjunction with parameter software 210 and data processor 220. The parameter software 210 resides on a program storage device 212 having a computer usable medium 214 (e.g., diskette, CD, DAT tape, or the like) for storing the program code. The program storage device 212 may be of a conventional variety, such as a conventional disk or memory device. The parameter software 210 may be created using general-purpose application development tools such as programming languages, graphical design tools, and commercially available reusable software components. A general database engine may be used to manage data storage and retrieval. The processor 220 is part of a general-purpose computer system. Any general-purpose computer may be used, provided that the processing power is sufficient to achieve the desired speed of computation for the amount of data being processed by the system.

In a calculation module 390, the milk production prediction and other calculations are solved according to steps 300, 350 and 500 in conjunction with transition monitor software 310 and data processor 320 (see FIG. 2). The calculation software 310 resides on a program storage device 312 having a computer usable medium 314, e.g., diskette, CD, DAT tape, or the like, for storing the program code. The program storage device 312 may be of a conventional variety, such as a conventional disk or memory device. The calculation software 310 may be created using general-purpose application development tools such as programming languages, graphical design tools, and commercially available reusable software components. A general database engine may be used to manage data storage and retrieval. The processor 320 is part of a general-purpose computer system. Any general-purpose computer may be used, provided that the processing power is sufficient to achieve the desired speed of computation for the amount of data being processed by the system.

It should be noted that, although the parameters module 290 and calculation module 390 may be provided separately as described above, they, and their component parts, may alternatively be combined. That is, the modules (290 and 390) may be provided as combined into a single module in which the respective software (210 and 310) is fully integrated and shares a single program storage device and data processor.

Once the calculation results are accessibly stored in a results database 690, they may be used in evaluating the condition of individuals and herds and in optimally managing their health and productivity. The results database 690 may be queried by an end user 780 who can request specific information from the system through a query 790 and thereby produce customized output 770. The system accommodates post-processing of the output data 770, allowing delivery in various formats and through various electronic media. The system can generate output 770 in the form of further analyses and presentations as graphs, spreadsheets, maps, HTML documents, or other formats. Queries 790 may be formulated to a user's specifications in order to create customized output to use in evaluations and in making management decisions. The output 770 can be delivered electronically through a variety of channels, including facsimile, e-mail, LANs, WANs and the worldwide web. It can also, of course, be provided in hard copy.

The results database 690 itself, or customized output data 770, may be incorporated into a dairy industry's information management system for intranet online access (via a LAN or WAN) to enable industry-wide access to results. In this way, the system of the present invention may be fully incorporated into a dairy's information system to provide a seamless interface to their current individual and herd management structure.

Although the present invention has been described in considerable detail with reference to certain exemplary versions or embodiments thereof, other versions and embodiments are possible. Therefore, the spirit and scope of any appended claims should not be limited to the description of the preferred versions contained herein.

What is claimed is:

1) A method of using a computer for calculating a prediction of milk production for one or more milk-producing animals without relying on factors related to the milk-producing animals' previous lactations so as to enable its use in evaluating and optimally managing the health and productivity of the one or more milk-producing animals comprising:
a) accessibly storing an animal data set comprising, for each of one or more milk-producing animals, a predicted transmitting ability for milk (PTA MILK), a current number of days in milk at a test day (CURR DIM);
b) accessibly storing a parameters data set comprising:
i) α, a regression coefficient intercept or overall mean,
ii) β, a regression coefficient associated with PTA MILK, and
iii) ε, a regression coefficient associated with CURR DIM;
c) for each of the one or more individual milk-producing animals, calculating an expected or predicted amount of milk produced by the individual milk-producing animal in the current lactation for the given time period (y) by summing α, (β*PTA MILK) and (ε*CURR DIM);
d) for each of the one or more individual milk-producing animals, calculating an index by subtracting the predicted amount of milk produced (y) from an actual amount of milk produced by the individual milk-producing animal in a current lactation for the given time period, which value may be measured and accessibly stored as part of the animal data set; and
e) accessibly storing the predicted milk production (y) and the index for each of the one or more milk-producing animals, and the output as desired for use in evaluating and optimizing health and productivity of the one or more milk-producing animals.

2) The method of claim 1 wherein the animal data set and parameter data set contains information regarding each animal's current state, but not including any information related to previous lactation.

3) The method of claim 1 wherein the animal data set contains data selected from one or more of the following data sets:
a. a predicted transmitting ability (PTA) for milk (PTA MILK);
b. the amount of milk actually produced on the First Test Day of the current lactation (i.e., MP_actual,first-test);
c. the amount of milk projected to be produced in 305 days of current lactation based on the MP_actual,first-test value (i.e., MP_actual,305) without herd production level adjustments;
d. the number of days milked when the first test was taken (CURR DIM, or current days in milk at the First Test Day);
e. the current lactation starting code (CURR LACT CODE), a code indicating whether or not lactation began following an abortion or following a normal calving;
f. the month in which the current lactation calving occurred (MO CURR CALV);
g. breed (BREED);
h. current lactation's milking frequency as of the test day (CURR MILKING FREQ);
i. age in months at current calving (AGE CURR CALV); and
j. identification of sire.

4) The method of claim 1 wherein the parameter data set contains data selected from one or more of the following data sets:
a. values for the intercept,
b. regression coefficients used in calculating projected milk production wherein:
i. α is a regression coefficient intercept or overall mean;
ii. β is a regression coefficient associated with PTA MILK;
iii. ε is a regression coefficient associated with CURR DIM;
iv. γ is a regression coefficient associated with AGE CURR CALV;
v. λ is a regression coefficient associated with (AGE CURR CALV)^{2; and}
vi. ζ is a regression coefficient associated with CURR MILKING FREQ; and
c. wherein the data sets are based on statistical analysis of data for animals in the relevant region of the country or world and on the time period for which the predicted production values are calculated.

5) The method of claim 1, wherein the predicted milk production y is calculated for either First Test Day or 305-day milk production prediction according to the following algorithm: Y=α+(β*PTA MILK)+(ε*CURR DIM) (Eq. 1a).

6) The method of claim 1, wherein the predicted milk production y is calculated for either First Test Day or 305-day milk production prediction according to the following algorithm: Y=α+(β*PTA MILK)+(ε*CURR DIM)+CURR LACT CODE factor+MO CURR CALV factor+(γ*AGE CURR CALV)+(λ*(AGE CURR CALV)^{2) (Eq.} 1b).

7) The method of claim 1, wherein the predicted milk production y is calculated for either First Test Day or 305-day milk production prediction according to the following algorithm: Y=α+(β*PTA MILK)+(ε*CURR DIM)+CURR LACT CODE factor+MO CURR CALV factor+(γ*AGE CURR CALV)+(λ*(AGE CURR CALV)²)+BREED factor+(ζ*CURR MILKING FREQUENCY) (Eq. 1c).

8) The method of claim 1, wherein index is calculated according to the following equation: Index=Actual Milk Production−y (Eq. 2), where: Actual Milk Production is the actual milk production by the individual animal for a particular time period, and when the time period is the first-test day, the Actual Milk Production is the actual amount of milk the individual produced on that day and when the time period is 305 days, the Actual Milk Production is a projected value for milk production during the first 305 days of the individual's current lactation, based on actual milk production at First Test Day, and y is the expected or predicted milk production by the individual for a particular time period.

9) The method of claim 1 further comprising calculating a herd-level value or index, wherein the herd-level value or index may be calculated by summing individual values over all individuals in the herd and dividing by the number of individuals, wherein the results can be used for the following purposes:
a. to optimally manage health and productivity of individuals and/or herds;
b. to compare within herd management practices such as differences between the transition programs applied to different individuals within the herd, and differences in practices employed during different periods of time;
c. to compare different herds to determine if management practices applied to one herd are more or less optimal than those applied to another;
d. to identify sires with the genetic tendency to father offspring with good health and productivity during transition periods which, together with the transition monitor values for individual animals, may be used to inform breeding programs in order to further improve the genetic health and productivity of herds; and
e. to assist herdsmen to identify sick animals at earlier stages of illness and improve response to treatment.

10) A computer implemented system, comprising a computer usable medium and computer readable code embodied on the computer usable medium for calculating a prediction of milk production of one or more milk-producing animals without relying on factors related to the milk-producing animals' previous lactations so as to enable its use in evaluating and optimally managing the health and productivity of the one or more milk-producing animals, the computer readable code comprising:
a. a computer readable code device for accessibly storing an animal input database set comprising for each of one or more milk-producing animals, a predicted transmitting ability for milk (PTA MILK), a current number of days in milk at a test day (CURR DIM);
b. a computer readable code device for accessibly storing a parameter input database set comprising:
i. α, a regression coefficient intercept or overall mean,
ii. β, a regression coefficient associated with PTA MILK, and
iii. ε, a regression coefficient associated with CURR DIM;
c. a computer readable code device configured to cause the computer to effect the, for each of the one or more individual milk-producing animals, calculating of an expected or predicted amount of milk produced by the individual milk-producing animal in the current lactation for the given time period (y) by summing α, (β*PTA MILK) and (ε*CURR DIM);
d. a computer readable code device configured to cause the computer to effect the, for each of the one or more individual milk-producing animals, calculating an index by subtracting the predicted amount of milk produced (y) from an actual amount of milk produced by the individual milk-producing animal in a current lactation for the given time period, which value may be measured and accessibly stored as part of the animal data set; and
e. a computer readable code device configured to cause the computer to accessibly store the predicted milk production (y) and the index for each of the one or more milk-producing animals, and the output as desired for use in evaluating and optimizing health and productivity of the one or more milk-producing animals.

11) A program storage device readable by a machine, tangibly embodying a program of instructions executable by the machine to perform method steps for calculating a prediction of milk production of one or more milk-producing animals without relying on factors related to the milk-producing animals' previous lactations so as to enable its use in evaluating and optimally managing the health and productivity of the one or more milk-producing animals, the method steps comprising:
a. accessibly storing an animal data set comprising, for each of one or more milk-producing animals, a predicted transmitting ability for milk (PTA MILK), a current number of days in milk at a test day (CURR DIM);
b. accessibly storing a parameters data set comprising:
i. α, a regression coefficient intercept or overall mean,
ii. β, a regression coefficient associated with PTA MILK, and
iii. ε, a regression coefficient associated with CURR DIM;
c. for each of the one or more individual milk-producing animals, calculating an expected or predicted amount of milk produced by the individual milk-producing animal in the current lactation for the given time period (y) by summing α, (β*PTA MILK) and (ε*CURR DIM);
d. for each of the one or more individual milk-producing animals, calculating an index by subtracting the predicted amount of milk produced (y) from an actual amount of milk produced by the individual milk-producing animal in a current lactation for the given time period, which value may be measured and accessibly stored as part of the animal data set; and
e. accessibly storing the predicted milk production (y) and the index for each of the one or more milk-producing animals, and the output as desired for use in evaluating and optimizing health and productivity of the one or more milk-producing animals.

12) An apparatus for calculating a prediction of milk production of one or more milk-producing animals without relying on factors related to the milk-producing animals' previous lactations so as to enable its use in evaluating and optimally managing the health and productivity of the one or more milk-producing animals, the apparatus comprising:
a. means for accessibly storing an animal data set comprising, for each of one or more milk-producing animals, a predicted transmitting ability for milk (PTA MILK), a current number of days in milk at a test day (CURR DIM);
b. means for accessibly storing a parameters data set comprising:
i. α, a regression coefficient intercept or overall mean,
ii. β, a regression coefficient associated with PTA MILK, and
iii. ε, a regression coefficient associated with CURR DIM;
c. means for each of the one or more individual milk-producing animals, calculating an expected or predicted amount of milk produced by the individual milk-producing animal in the current lactation for the given time period (y) by summing α, (β*PTA MILK) and (δ*CURR DIM);
d. means, for each of the one or more individual milk-producing animals, for calculating an index by subtracting the predicted amount of milk produced (y) from an actual amount of milk produced by the individual milk-producing animal in a current lactation for the given time period, which value may be measured and accessibly stored as part of the animal data set; and
e. means for accessibly storing the predicted milk production (y) and the index for each of the one or more milk-producing animals, and the output as desired for use in evaluating and optimizing health and productivity of the one or more milk-producing animals.
